(19) United States
(12) Patent Application Publication
(10) Pub. No.: US 2018/0202622 A1
(43) Pub. Date: Jul. 19, 2018

(54) FLEXIBLE LIGHT BAR ASSEMBLY

(71) Applicant: Geoffrey Paul Arce, Norman, OK (US)

(72) Inventor: Geoffrey Paul Arce, Norman, OK (US)

(21) Appl. No.: 15/919,540

(22) Filed: Mar. 13, 2018

Related U.S. Application Data
(60) Provisional application No. 62/463,078, filed on Feb. 24, 2017.

(51) Int. Cl. F21S 4/28; F21V 21/08; F21V 5/00; F21V 23/00; B60Q 1/46; F21S 43/14; F21S 43/20

(52) U.S. Cl. CPC F21S 4/28; F21V 21/0808; F21V 5/007; F21Y 2115/10; B60Q 1/46; F21S 43/14; F21S 43/26; F21V 23/003

(57) ABSTRACT

A flexible light bar assembly conforms onto a surface of any shapes and curvatures within a vehicle, is disclosed. The light bar assembly comprises, a flexible silicone housing, a light projection unit embedded within the silicone housing having a plurality of light emitting source. A lens is positioned over each of the light emitting source to provide a narrow beam of high intensity light and to adjust an illuminating angle of the light. Further, an adhesive seal disposed at a front portion of the silicone housing for fastening the light bar assembly against the transparent surface of the vehicle. The flexible silicone housing is configured to provide perfect conformity of the light bar assembly to the transparent surface on fastening the adhesive seal against the transparent surface. The light projection unit further comprises a controller module to control the operation of the plurality of light emitting source.

### BACKGROUND OF THE INVENTION

### A. Technical Field

The present invention generally relates to a light bar for a vehicle, and more specifically relates to a flexible light bar assembly that conforms onto a surface of different shapes and curvatures.

### B. Description of Related Art

Light bar assemblies are used as an indication system in vehicles such as ambulances, fire trucks and law enforcement vehicles. Traditionally, light bar assemblies are mounted to the exterior roof of the vehicle. Positioning the light bar at the exterior roof of the vehicle establishes the goal of ensuring excellent visibility. However, exterior roof mounting of light bar includes significant drawback such as interference with the aerodynamics of the vehicle, increased noise and requires alteration of the roof the vehicle which may decrease the resale value of the vehicle.

To overcome the above drawbacks, interior light bars have been developed, which is configured to install on the interior side of the vehicle windshield. However, interior light bars have their own drawbacks. Interior light bars are difficult to install, which requires metal brackets fastened or clamped to the vehicle chassis. Further, they also create a condition known as flashback, when the edge of the bar is not 100% sealed against the windshield, and the light from the bar reflects off the windshield into the driver's eyes or vehicle when the light is activated. Further, the light bars are made with a metal housing usually weighing several pounds. If the vehicle was ever to be in a collision, the light bar(s) could become dangerous projectiles. Further, some existing light bars use a housing with a right-angled side which is pushed against the transparent glass surface via few brackets held by clamping force from vehicles or by any other means of fastening. Most of the mounting method utilizes some bracket system which is difficult to install and does not offer complete conformity to the support surface curves. As the structure of the housing is solid, which acts as a main reason for non-conformity of light bar to the glass surface causing flashback.

Therefore, there is a need for a light bar assembly that eliminates the foregoing issues relating to non-conformity of light bar assembly, weight of the light bar assembly and flashback.

### SUMMARY OF THE INVENTION

The present invention discloses a flexible light bar assembly that conforms onto a surface of different shapes and curvatures. The flexible light bar assembly of the present invention comprises a flexible silicone housing that conforms to any shape of support surface. The flexible light bar assembly further comprises an adhesive edge that facilitates easy installation of the light bar assembly. The adhesive edge and the flexible silicone housing creates a solid seal between the support surface and the light bar assembly eliminating flashback. Further, securing the light bar assembly with the adhesive seal reduces the chance of unintended removal. Further, the silicone housing weighs less and thin in structure, which would not pose any danger in case of a vehicle collision.

In an embodiment, the flexible light bar assembly further comprises a light projection unit embedded within the silicone housing. The light projection unit comprises a plurality of light emitting source embedded within the silicone housing by providing a clear path for emission of light. In an embodiment, the light emitting source is a Light Emitting Diode (LED). In an embodiment, the light projection unit further comprises a controller module to control the operation of the plurality of light emitting source. In one embodiment, the light projection unit further comprises one or more LED protection resistors connecting the plurality of light source and the controller module. The LED protection resistors connects the plurality of light source via a conductive lead of the light emitting source. Further, a lens is positioned over each of the light emitting source to provide a narrow beam of high intensity light and to adjust an illuminating angle of the light.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The embodiments herein will be better understood from the following detailed description with reference to the drawings, in which:

FIG. 1A exemplarily illustrates a rear view of a vehicle installed with a flexible light bar assembly in accordance with various embodiments of the present invention.

FIG. 1B exemplarily illustrates a front view of a vehicle installed with a flexible light bar assembly in accordance with various embodiments of the present invention.

FIG. 2 exemplarily illustrates a perspective view of the flexible light bar assembly in an embodiment of the present invention.

FIG. 3 exemplarily illustrates a rear view of the flexible light bar assembly in an embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

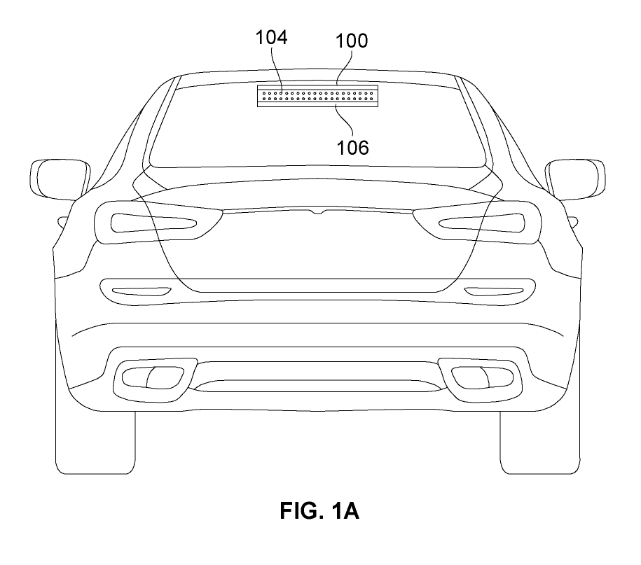

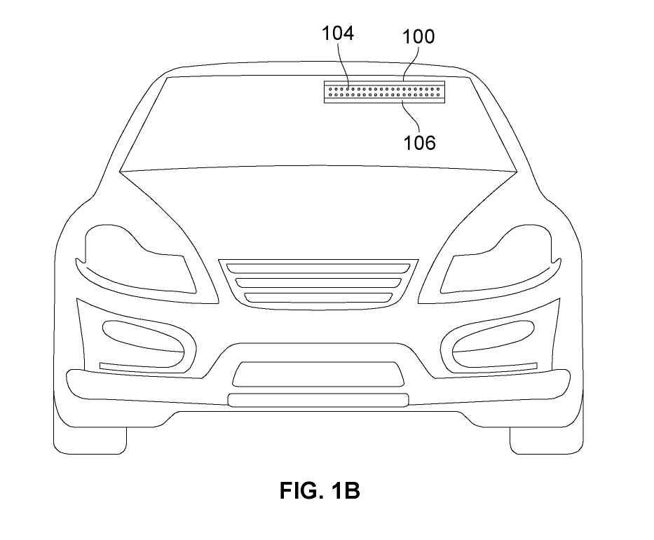

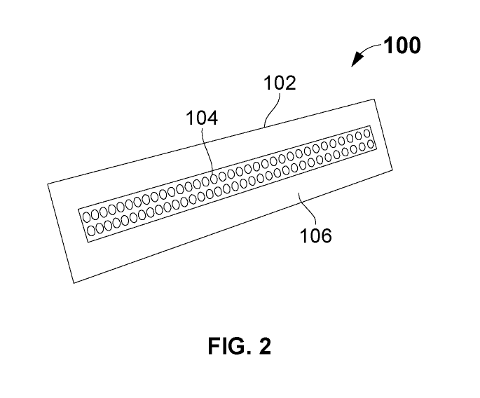

Referring to FIG. 1A and FIG. 2, the present invention discloses a flexible light bar assembly 100 installed within a transparent surface of a vehicle. The light bar assembly 100 comprises a flexible housing 102, which is configured to adapt and conform to the curvature shape of the transparent surface or a support surface to which the light bar assembly 100 is installed. In one embodiment, the flexible housing 102 is made of silicone material. The light bar assembly 100 further comprises a light projection unit embedded within the flexible housing 102. The light projection unit comprises a plurality of light emitting source 104. In one embodiment, the light emitting source 104 embedded within the flexible housing 102 by providing a clear path for emission of light form the light emitting source 104. In one embodiment, the light emitting source 104 is a Light Emitting Diode (LED). Further, a lens is positioned over each of the light emitting source 104 to provide a narrow beam of high intensity light. In one embodiment, the lens is configured to adjust an illuminating angle of the light. In another embodiment, the lens is configured to rotate the direction of the beam downwards to compensate for the angled windshield. FIG. 1B exemplarily illustrates a front view of a vehicle installed with a flexible light bar assembly in accordance with various embodiments of the present invention.

In one embodiment, the light projection unit further comprises one or more LED protection resistor. In one embodiment, the leads of the plurality of light emitting source 104 are connected in series or parallel circuit to the LED protection resistor. Further, the LED protecting resistor connected to a controller module or a power source. In one embodiment, the light bar assembly 100 comprises an adhesive seal 106 disposed at a front portion of the silicone housing 102 or light emitting side of the light bar assembly 100. The adhesive seal 106 is configured to fasten the light bar assembly 100 against the transparent surface of the vehicle. In one embodiment, the flexible housing 102 and the adhesive seal 106 is configured to provide a solid seal between the transparent surface and the light bar assembly 100 preventing reflection of light into the vehicle. In one embodiment, the flexible housing 102 and the adhesive seal 106 is configured to provide perfect conformity of the light bar assembly 100 to the transparent surface on fastening the adhesive seal 106 against the transparent surface. In one embodiment, the light emitting source 104 is controlled remotely by applying power signal to a connection on the controller module.

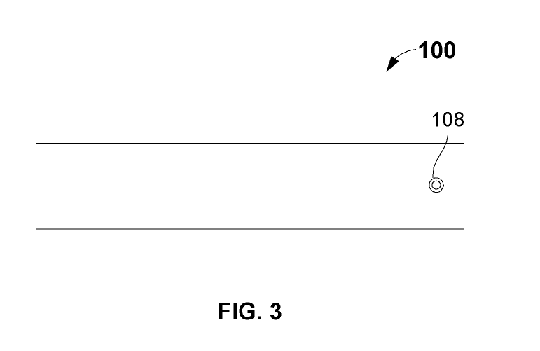

FIG. 3 illustrates the rear view of the light bar assembly 100 in an embodiment of the present invention. In another embodiment, a power controller of the lights in the vehicle could be wired to the controller module of the light bar assembly 100. In one embodiment, the rear side of the flexible housing 102 comprises a switch 108 to control the operation of the light emitting source 104 or other lighting equipment in the vehicle by a user. In one embodiment, the flexible light bar assembly 100 further comprises a power module. In one embodiment, the power module could be connected to the switched power source using appropriate circuit protection.

In one embodiment, the method of manufacturing the flexible light bar assembly 100 is explained as follows. Initially, LED circuit is placed in the silicone mold. In another embodiment, the LED circuit is placed in the silicone mold by providing a clear path for emission of light from LED. In one embodiment, the top of the LEDs would be covered to block the silicone mold and to provide a clear path for emission of light from the LEDs. Then, the mold is dried and extracted.

In one embodiment, the adhesive edge or seal 106 are placed on the perimeter of the flexible housing 102 on the light emitting side. In one embodiment, the adhesive edge 106 could be a strong adhesive tape (such as 3M's VHB Tape) which is dimensioned to the size of the silicone mold, and then cut to a shape so that it's not blocking any LEDs. One side of the tape would be adhered to the mold, other side of the tape is left covered until installation. In one embodiment, the LED circuit could be coupled with the controller to create flashing light effects from the LED for use in emergency vehicles. In one embodiment, switch 108 are installed at the rear side of the flexible housing 102 to allow operator or user to control the operation of flexible light bar assembly 100.

In one embodiment, a desired color of LED could be chosen based on the applications. In one embodiment, the flexible housing 102 could also be dimensioned to various shape based on the applications. In one embodiment, the flexible housing 102 could be molded to any height or width with 1-2 centimeters depth. The depth of the housing 102 is chosen depending upon the height of the LED. In one embodiment, the flexible housing 102 is in rectangular bar shape. In one embodiment, the method of installation of light bar assembly 100 is explained as follows. The installation involves the step of: cleaning the transparent surface where the light bar assembly 100 need to be placed and; pressing the adhesive edge 106 against the transparent surface. Because of the flexible housing 102 and the adhesive edge 106, the light bar assembly 100 creates a seal around every edge of the light bar assembly 100 against the transparent surface.

Accordingly, the advantages of the present invention include: creates a solid seal between the support surface and the light bar assembly 100 eliminating flashback via the adhesive edge 106 and the flexible housing 102; reduces the chance of unintended removal of light bar assembly 100; facilitates easy installation of the light bar assembly 100; the design and structure of the light bar assembly 100 would not pose any danger in case of a vehicle collision; and could be utilized in anywhere such as vehicles, shopping malls where emission of light through a transparent surface is required.

Although a single embodiment of the invention has been illustrated in the accompanying drawings and described in the above detailed description, it will be understood that the invention is not limited to the embodiment developed herein, but is capable of numerous rearrangements, modifications, substitutions of parts and elements without departing from the spirit and scope of the invention.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A flexible light bar assembly for mounting onto a transparent surface, comprising:
a flexible housing;
a light projection unit embedded within the silicone housing, comprising a plurality of light emitting source; and
an adhesive seal disposed at a front portion of the silicone housing for fastening the light bar assembly against the transparent surface.

2. The flexible light bar assembly according to claim 1, further comprises a lens positioned over each of light emitting source to provide a narrow beam of high intensity light and to adjust an illuminating angle of the light.

3. The flexible light bar assembly according to claim 1, wherein the flexible housing is made of silicone.

4. The flexible light bar assembly according to claim 1, wherein the light emitting source is embedded within the flexible housing by providing a clear path for emission of light.

5. The flexible light bar assembly according to claim 1, wherein the flexible silicone housing is configured to provide perfect conformity of the light bar assembly to the transparent surface on fastening the adhesive seal against the transparent surface.

6. The flexible light bar assembly according to claim 1, wherein the light projection unit further comprises a controller module to control the operation of the plurality of light emitting source.

7. The flexible light bar assembly according to claim 1, wherein the light emitting source is a Light Emitting Diode (LED).

8. The flexible light bar assembly according to claim 1, wherein the light projection unit further comprises LED protecting resistors connecting the plurality of light source and the controller module.

9. The flexible light bar assembly according to claim 1, wherein the light protecting resistors connects the plurality of light source via a conductive lead of the light emitting source.

10. The flexible light bar assembly according to claim 1, wherein the adhesive seal is configured to provide a solid seal between the transparent surface and the light bar preventing flashback on activation of the light projection unit.
